(19) United States
(12) Patent Application Publication
(10) Pub. No.: US 2016/0053390 A1
(43) Pub. Date: Feb. 25, 2016

(54) FLUID DISTRIBUTOR, FUEL CELL, OR ELECTROLYZER, AND METHOD FOR THE FUNCTION OF A FLUID DISTRIBUTOR

(71) Applicant: ROBERT BOSCH GMBH, Stuffgart (DE)

(72) Inventor: Sebastian Maass, Renningen-Malmsheim (DE)

(21) Appl. No.: 14/888,487

(22) PCT Filed: Apr. 28, 2014
(86) PCT No.: PCT/EP2014/058552

§ 371 Date: Nov. 2, 2015

(30) Foreign Application Priority Data
May 2, 2013 (DE) 10 2013 208 081.6

(51) Int. Cl. C25B 15/08; H01M 8/02

(52) U.S. Cl. CPC C25B 15/08; H01M 8/02; H01M 2250/10; H01M 2250/20; H01M 2250/30

(57) ABSTRACT

The invention relates to a fluid distributor (1). The fluid distributor (1) is designed to distribute a fluid flow (2) into at least two fluid sub-flows (3) or to combine at least two fluid sub-flows (3) of a fluid flow (2), and the fluid distributor (1) is equipped with a flame trap (4). The invention further relates to a fuel cell (5) comprising such a fluid distributor (1), to an electrolyzer (6) with such a fluid distributor (1), and to a method for the function of a fluid distributor (1), wherein a fluid flow (2) is separated into at least two fluid sub-flows (3) or at least two fluid sub-flows (3) are combined into a fluid flow (2) by means of the fluid distributor (1), and the fluid distributor (1) prevents a flame front from occurring and/or from spreading.

### BACKGROUND OF THE INVENTION

The present invention relates to a fluid distributor. The fluid distributor is designed to distribute a fluid flow into at least two fluid sub-flows or to combine at least two fluid sub-flows of a fluid flow. The invention further relates to a fuel cell comprising a fluid distributor, to an electrolyzer with a fluid distributor and to a method for the function of a fluid distributor, wherein a fluid flow is separated into at least two fluid sub-flows or at least two fluid sub-flows are combined into a fluid flow by means of the fluid distributor.

In fuel cells and electrolyzers, fluids, such as, for example, the fuel which has been supplied or generated and the oxidizing agent which has been supplied or generated, are separated by means of thin separators. In order to facilitate the reaction, highly active catalysts can furthermore be used in both devices. In the event of a failure of the separator or even if holes form in the separator, the fuel and the oxidizing agent can mix. There is then the possibility that a combustible and/or explosive mixture forms from such a mixture which can ignite particularly at an existing catalyst.

Fuel cells and electrolyzers are usually designed in each case to increase the effectivity of the flow-rate such that a plurality of fuel cells or, respectively, electrolyzers are combined to form a system—comprising a stack of fuel cells or electrolyzers. Because it cannot be ruled out that a leakage may form in one of fuel cells used in each case or in one of the electrolyzers used and that the leaking fuel may subsequently ignite, it is known to design the entire stack architecture, i.e. the gas distribution and consolidation of the entire stack, in such a way that a flame front can be prevented from spreading from one fuel cell to the next or, respectively, from one elecrolyzer to the next. A flame front cannot, however, thereby be prevented from spreading within a single fuel cell, or, respectively, a single electrolyzer.

### SUMMARY OF THE INVENTION

It is therefore the aim of the present invention to at least partially rectify the aforementioned disadvantages of known fluid distributors, fuel cells, electrolyzers and methods for the function of a fluid distributor. It is particularly the aim of the present invention to provide a fluid distributor, a fuel cell, an electrolyzer as well as a method for the function of a fluid distributor which can be secured as simply, cost effectively and technically sound as possible.

The aforementioned aim is met by a fluid distributor according to the invention, by a fuel cell according to the invention, by an electrolyzer according to the invention as well as by a method for the function of a fluid distributor according to the invention. Further features and details of the invention ensue from the claims, the description and the drawings. In so doing, the features and details which are described in connection with the fluid distributor according to the invention also, of course, apply in connection with the fuel cell according to the invention, the electrolyzer according to the invention and the method according to the invention and in each case vice versa; so that, with respect to the disclosure, reference is or can always expediently be made to the individual aspects of the invention.

In a first aspect of the invention, the aim is met by a fluid distributor, wherein the fluid distributor is designed to distribute a fluid flow into at least two fluid sub-flows or to combine at least two fluid sub-flows of a fluid flow. The fluid distributor according to the invention is particulary characterized in that said fluid distributor is equipped with a flame trap. In so doing, the fluid distributor constitutes the link between a fluid line and the place of operation of the fluid. The place of operation can, for example, be the active area of a fuel cell or of an electrolyzer. A fluid flow is divided into at least two fluid flows in the fluid distributor. The individual fluid flows are supplied by the fluid distributor to the place of operation, in turn, for example, in a fuel cell or an electrlyzer. According to the invention, the fluid distributor can also be designed to reverse the process, i.e. to combine fluid flows to form a single fluid flow downstream of the place of operation. The fluid divided by the fluid distributor can often be combustible or highly reactive. If damage occurs, for example at the place of operation, an ignition of the fluid can therefore not be ruled out. According to the invention, the fluid distributor is therefore equipped with a flame trap. In this way, an ignition of the fluid cannot spread beyond the fluid distributor. The safety of a device in which an inventive fluid distributor is installed can thereby be significantly increased because a flame or a flame front can already be prevented from spreading or, respectively, developing by the fluid distributor according to the invention.

Provision can be made in the fluid distributor according to the invention for the flame trap to have a porous structure at least in certain sections. Such porous structures have small standard gap widths, which reliably prevent a flame from spreading. A flame can only spread if the standard gap width has been exceeded. For example, the standard gap width for hydrogen is approximately 0.25 mm at atmospheric conditions. In this case, the standard gap width is dependent upon the operating pressure of the fluid in so far as a higher operating pressure necessitates a smaller standard gap width. The standard gap width is, for example, 0.15 mm for the very reactive mixture of approximately 25% hydrogen in air at an operating pressure of 25 bar. Such small standard gap widths can be particularly easily implemented by the use of a structure for the flame trap which is at least porous in certain sections. Such a porous structure can, for example, be achieved by sintered metals, metallic fiber sintered mats, metal foams and/or expanded metals. In addition, a porous structure can also be formed by means of channel structures. In this case, it should be noted that the channel structures are small enough in order to comply with standard gap widths. The use of a porous structure thus represents a reliable way to implement a flame trap in a fluid distributor.

In the case of the fluid distributor according to the invention, provision can furthermore be made in a preferable manner for the flame trap to comprise a material having high thermal conductivity. By means of a material having high thermal conductivity, the flame trap has an increased heat exchange capability. As a result, it is possible to withdraw thermal energy from a flame front so that the flames of the flame front are extinguished or do not develop at all. This also constitutes a reliable and simple way to implement a flame trap in a fluid distributor.

In the case of a fluid distributor according to the invention, provision can additionally be made for the flame trap to have a catalytic coating. A combustion process constitutes an oxidation. Radicals can be withdrawn in the flame front by means of a catalytic coating of the flame trap so that this oxidation reaction breaks down and the flame is extinguished. The catalytic coating can also reliably prevent a flame front from spreading or a flame front from developing. In so doing, the catalytic coating of the flame trap must not be applied continuously. An application of catalytic coating in certain sections, for example by means of sputtering, can already be sufficient.

It is also additionally conceivable with regard to the fluid distributor according to the invention that the catalytic coating comprises a precious metal, in particular platinum. Precious metals are chemically particularly well suited to capturing and sequestering radicals from a flame front. Particularly platinum has in this regard an especially high capture cross section. The function of the flame trap can therefore again be improved by using precious metals in the catalytic coating.

In the case of a fluid distributor according to the invention, provision can be made in a particularly preferable manner for the fluid distributor to be able to be used for distributing or combining a fluid flow in a fuel cell and/or in an electrolyzer. Combustible and/or highly reactive fluids are present particularly in fuel cells and electrolyzers. Pure hydrogen gas and pure oxygen gas can thus, for example, be present in fuel cells. Electrolyzers are, for example, used in order to precisely generate these highly reactive gases. A fluid distributor according to the invention can be used particularly in an inlet flow region, an outlet flow region and/or in an active area of the fuel cell or the electrolyzer. A reliable prevention of flames from forming or, respectively, a reliable prevention of flames from spreading already in the fuel cell or in the electrolyzer prevents a stack in which the fuel cell or the electrolyzer is installed from being endangered as a whole by the flame formation. This applies here to the fuel cell as well as to the electrolyzer. The latter is, in fact, usually of more stable design than a fuel cell but is basically exposed to the same problem of flame formation, for example if a hole develops in a separator.

According to a second aspect of the invention, the aim is met by a fuel cell comprising a fluid distributor. Provision can particularly be made with regard to a fuel cell according to the invention for the fluid distributor to be designed according to the first aspect of the invention. All of the advantages, which have been described in regard to the fluid distributor according to the first aspect of the invention, also apply, of course, to a fuel cell according to the invention which comprises such a fluid distributor according to the first aspect of the invention.

In addition, provision can be made with regard to a fuel cell according to the invention for the fuel cell to be used for stationary, portable and/or automotive applications. An inventive fuel cell can thus be used in a variety of ways. There are no restrictions with regard to the place of operation or the intended purpose for an inventive fuel cell. In all possible application variants, reliability and security of the system can be increased by using a fuel cell according to the invention.

According to a third aspect of the invention, the aim is met by an electrolzer comprising a fluid distributor. An inventive electrolyzer is particularly characterized in that the fluid distributor is designed according to the first aspect of the invention. All of the advantages which have been described with regard to the first aspect of the invention also, of course, apply to an electrolyzer according to the invention which is equipped with a fluid distributor according to the first aspect of the invention.

According to a fourth aspect of the invention, the aim is met by a method for the function of a fluid distributor, wherein a fluid flow is distributed into at least two fluid sub-flows or at least two fluid sub-flows are combined into one fluid flow. The inventive method for the function of a fluid distributor is particularly characterized in that a flame front is prevented from developing and/or spreading by the fluid distributor. By preventing a flame from developing and/or spreading already in the fluid distributor, a combustion reaction can effectively be prevented from spreading beyond the fluid distributor. In so doing, provision can particularly be made for the fluid distributor to comprise a flame trap or itself to be designed as a flame trap. It is particularly preferable in this case for the fluid distributor to be designed according to the first aspect of the invention. All of the advantages which have been described with regard to a fluid distributor according to the first aspect of the invention also, of course, apply in this case to the inventive method for the function of a fluid distributor. Especially when using a method according to the invention in a fuel cell or an electrolyzer, a flame front, which has developed or is developing, can also thereby be effectively prevented from spreading beyond the fuel cell or the electrolyzer. The safety of a device in which an inventive method for the function of a fluid distributor is carried out can thus be significantly increased.

### BRIEF DESCRIPTION OF THE DRAWINGS

The fluid distributor according to the invention and the modifications thereto as well as the advantages thereof, the fuel cell according to the invention and the modifications thereto as well as the advantages thereof, the electrolyzer according to the invention and the modification thereto as well as the advantages thereof and the method according to the invention and the modification thereto as well as the advantages thereof are subsequently described in greater detail with the aid of the drawing. In the drawing:

FIG. 1 shows schematically a device comprising a fluid distributor according to the invention.

### DETAILED DESCRIPTION

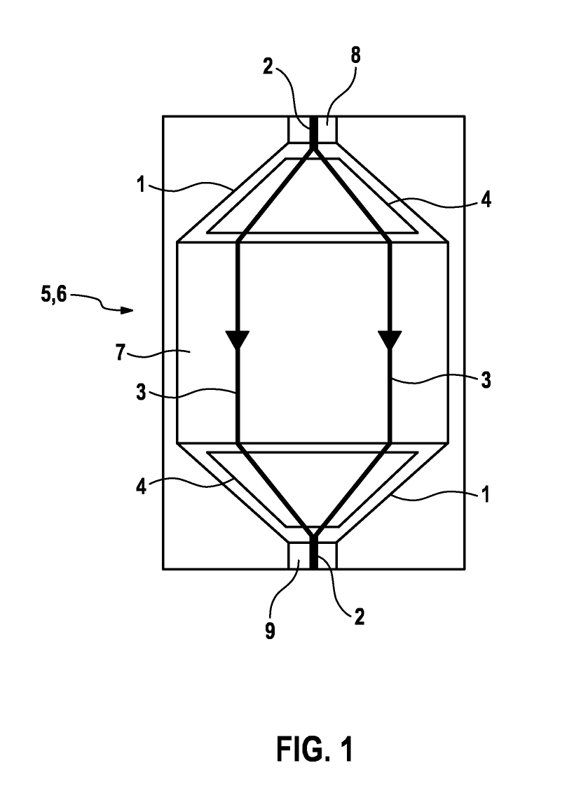

A device comprising a fluid distributor 1 according to the invention is shown in FIG. 1. In this case, the device can be a fuel cell 5 or an electrolyzer 6. An active area 7 is located in the device, in which, in the case of a fuel cell 5, fluids react with one another or, in the case of an electrolyzer 6, fluids are broken down into two or a plurality of constituents. The active area 7 is supplied by a fluid feed 8 comprising a fluid flow 2, which is channeled off by a fluid discharge 9 downstream of the active area 7. A fluid distributor 1, in which the fluid flow 2 is divided into two fluid sub-flows 3, is located between the fluid feed 8 and the active area 7. Subsequent to the active area 7, a further fluid distributor 1 is located between said active area 7 and the fluid discharge 9. The two fluid sub-flows 3 are combined again into a large fluid flow 2 in this further fluid distributor 1. The two fluid sub-flows 3 are only shown here as an example for a plurality of fluid sub-flows 3, which flow through the active area 7. Both fluid distributors 1 are equipped according to the invention with a flame trap 4. The flame traps can, of course, also extend into the active area 7. The flame traps can, for example, have a porous structure, whereby only small standard gap widths are provided for the individual fluid flows 3 to pass through the flame trap 4. Such porous structures can, for example, be constituted by sintered metals, metallic fiber sintered mats, metallic sponges and/or expanded metals. The structures are thereby preferably configured in such a way that the flow resistance for the gas distribution is not overly increased. In addition, the flame traps 4 can comprise a material having a high thermal conductivity. Metals, for example, also lend themselves well as material for the flame traps 4 in this case. Heat energy can be removed from a flame front by means of a high thermal conductivity of the material of said flame traps, whereby the flame front can be extinguished A catalytic coating within the flame trap 4 in the fluid distributor 1 constitutes a further option to further improve said flame trap 4. In so doing, the flame trap 4 is, for example, coated with a precious metal by sputtering. Radicals are removed from the flame front by means of the precious metal, which in turn leads to the flame being extinguished by interrupting the underlying oxidation reaction. If a flame forms in the active area, said flame is reliably stopped by the two fluid distributors designed according to the invention, in particular by the flame traps 4 in the fluid distributors 1 designed according to the invention. The flame front can be reliably prevented from spreading beyond the individual fuel cell 5 or, respectively, the individual electrolyzer 6. As a result, the safety and reliability of the device, in which the fuel cell 5 or, respectively, the elctrolyzer 6 is installed, can be increased overall. Because highly combustible and/or highly reactive fluids, such as, for example, hydrogen or oxygen, can particularly be used in fuel cells 5 and electrolyzers 6, this represents a large increase in the operating safety and reliability of said devices.

1. A fluid distributor (1) configured to distribute a fluid flow (2) into at least two fluid sub-flows (3) or to combine at least two fluid sub-flows (3) of a fluid flow (2), characterized in that the fluid distributor (1) is equipped with a flame trap (4).

2. The fluid distributor (1) according to claim 1, characterized in that the flame trap (4) has a porous structure at least in certain sections.

3. The fluid distributor (1) according to claim 1, characterized in that the flame trap (4) comprises a material having a high thermal conductivity.

4. The fluid distributor (1) according to claim 1, characterized in that the flame trap (4) has a catalytic coating.

5. The fluid distributor (1) according to claim 4, characterized in that the catalytic coating has a precious metal.

6. The fluid distributor (1) according to claim 1, characterized in that the fluid distributor (1) is configured to be used to distribute or combine a fluid flow (2) in at least one of a fuel cell (5) and an electrolyzer (6).

7. A fuel cell (5) comprising a fluid distributor (1) according to claim 1.

8. The fuel cell (5) according to claim 7, characterized in that the fuel cell (5) is configured to be used for stationary, portable and/or automotive applications.

9. An electrolyzer (6) comprising a fluid distributor (1) according to claim 1.

10. A method for the function of a fluid distributor (1), wherein a fluid flow (2) is separated into at least two fluid sub-flows (3) or at least two fluid sub-flows (3) are combined into a fluid flow (2) by means of the fluid distributor (1), characterized in that the fluid distributor (1) prevents a flame front from occurring and/or from spreading.

11. The fluid distributor (1) according to claim 4, characterized in that the catalytic coating includes platinum.

12. A fluid distributor (1) comprising
an active area configured to distribute a fluid flow (2) into at least two fluid sub-flows (3) or to combine at least two fluid sub-flows (3) of a fluid flow (2), and
a flame trap (4) for preventing a flame front from occurring or from spreading.

13. The fluid distributor (1) according to claim 12, characterized in that the flame trap (4) has a porous structure at least in certain sections.

14. The fluid distributor (1) according to claim 12, characterized in that the flame trap (4) comprises a material having a high thermal conductivity.

15. The fluid distributor (1) according to claim 12, characterized in that the flame trap (4) has a catalytic coating.

16. The fluid distributor (1) according to claim 15, characterized in that the catalytic coating has a precious metal.

17. The fluid distributor (1) according to claim 15, characterized in that the catalytic coating includes platinum.

18. The fluid distributor (1) according to claim 12, characterized in that the fluid distributor (1) is configured to be used to distribute or combine a fluid flow (2) in at least one of a fuel cell (5) and an electrolyzer (6).
